(19) United States
(12) Patent Application Publication
(10) Pub. No.: US 2026/0227928 A1
(43) Pub. Date: Aug. 6, 2026

(54) DATA ARRAY MODIFICATION DEVICE, INFORMATION PROCESSING APPARATUS, DATA ARRAY MODIFICATION METHOD, AND COMPUTER-READABLE STORAGE MEDIUM

(71) Applicant: Fujitsu Limited, Kawasaki-shi (JP)

(72) Inventor: Katsuhiro YODA, Kodaira (JP)

(73) Assignee: Fujitsu Limited, Kawasaki-shi (JP)

(21) Appl. No.: 19/463,444

(22) Filed: Jan. 29, 2026

(30) Foreign Application Priority Data
Feb. 6, 2025 (JP) 2025-018104

(51) Int. Cl. G06F 3/06

(52) U.S. Cl. CPC G06F 3/0655; G06F 3/0604; G06F 3/0673

(57) ABSTRACT

A data array modification device modifies an array of data read from a memory to an array executable by a computational array including a plurality of computational elements arranged in a matrix, and includes an input data selector configured to select a data group including a predetermined number of first data to be input to the computational array in a single input, from among a plurality of data read from an area having consecutive addresses in the memory, and an array generator configured to generate data to be output to the computational array by inserting an interval between the predetermined number of first data of the data group selected by the input data selector and shifting the data group from a head position.

### CROSS-REFERENCE TO RELATED APPLICATIONS

This application is based upon and claims the benefit of priority of Japanese Patent Application No. 2025-018104, filed on Feb. 6, 2025, the entire contents of which are incorporated herein by reference.

### FIELD

Certain aspects of the embodiments discussed herein are related to data array modification devices, information processing apparatuses, data array modification methods, and non-transitory computer-readable storage media.

### BACKGROUND

Matrix computations are often extensively used in machine learning such as deep learning, high performance computing (HPC), artificial intelligence (AI), or the like. A known accelerator has a computational array composed of multiple processing elements arranged in a matrix and connected to each other in order to perform a large-scale matrix computation at a high speed (refer to Patent Documents 1 and 2, for example).

For example, the computational array of this type of accelerator has a switching circuit arranged around each processing element, and the switching circuit can switch a connection between the processing elements or a connection between a processing element and a data terminal (refer to Patent Documents 3 and 4, for example).

### PRIOR ART DOCUMENTS

### Patent Documents

[Patent Document 1] Japanese Laid-Open Patent Publication No. 2024-038122
[Patent Document 2] U.S. Patent Application Publication No. 2019/0236049
[Patent Document 3] U.S. Patent Application Publication No. 2019/0317770
[Patent Document 4] Japanese National Publication of International Patent Application No. 2020-522825

In a case where multiple switching circuits are provided in the computational array including the multiple processing elements, a control signal for controlling the operation of each processing element and a control signal for controlling the switching of each switching circuit are supplied to the computational array. As a result, a large number of control signal lines is wired the computational array, to increase a circuit size of the computational array. In addition, as a distance between the processing elements increases and a wiring load between the processing elements increases, a charging and discharging current of the wiring increases to increase a power consumption of the computational array, and a performance of the computational array may deteriorate. Further, in a case where a control of a data array modification device and a control of the computational array are performed by a single controller, a load on the controller increases.

### SUMMARY

One object according to an aspect of the embodiments of the present disclosure is to reduce a load on a controller that controls a computational array while suppressing deterioration in a performance of the computational array, by disposing a data array modification device that modifies an array of data to be supplied to the computational array outside the computational array and autonomously operating the data array modification device.

According to an aspect of the embodiments of the present disclosure, a data array modification device modifies an array of data read from a memory to an array executable by a computational array including a plurality of computational elements arranged in a matrix, and includes an input data selector configured to select a data group including a predetermined number of first data to be input to the computational array in a single input, from among a plurality of data read from an area having consecutive addresses in the memory; and an array generator configured to generate data to be output to the computational array by inserting an interval between the predetermined number of first data of the data group selected by the input data selector and shifting the data group from a head position.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of a data array modification device according to an embodiment;

FIG. 2 is a block diagram illustrating an example of an information processing apparatus equipped with the data array modification device of FIG. 1;

FIG. 3 is an explanatory diagram illustrating a problem in a case where the data array modification device of FIG. 1 is not used;

FIG. 4 is an explanatory diagram illustrating an outline of operations of an input data selector and expansion circuitry in FIG. 1;

FIG. 5 is an explanatory diagram illustrating an example of an algorithm of an operation in which the input data selector of FIG. 4 acquires data to be processed from a data buffer;

FIG. 6 is a flow chart illustrating an example of the operation of the input data selector illustrated in the algorithm of FIG. 5;

FIG. 7 is an explanatory diagram illustrating an example of an operation of updating a pointer;

FIG. 8 is an explanatory diagram illustrating an example of a configuration of the expansion circuitry of FIG. 4;

FIG. 9 is an explanatory diagram illustrating an outline of an operation of the expansion circuitry of FIG. 8;

FIG. 10 is an explanatory diagram illustrating features in a case where a data array in a column direction is modified by the expansion circuitry of FIG. 8;

FIG. 11 is an explanatory diagram illustrating an example of an algorithm for generating a selection signal in the expansion circuitry of FIG. 8;

FIG. 12 is a flow chart illustrating an example of a procedure for generating the selection signal illustrated by an algorithm of the expansion circuitry of FIG. 11;

FIG. 13 is a block diagram illustrating an example of the data array modification device according to another embodiment;

FIG. 14 is an explanatory diagram illustrating an outline of functions of transposition circuitry included in the expansion circuitry of FIG. 13;

FIG. 15 is a circuit diagram illustrating an example of a configuration of the expansion circuitry of FIG. 13;

FIG. 16 is a block diagram illustrating an example of the data array modification device according to another embodiment;

FIG. 17 is an explanatory diagram illustrating an example of a divisor table of FIG. 16; and

FIG. 18 is an explanatory diagram illustrating an example of a configuration of a column selector of FIG. 16.

### DESCRIPTION OF EMBODIMENTS

Hereinafter, embodiments will be described with reference to the drawings. In the following description, a signal line through which a signal is transmitted is designated by the same reference numeral as the name of the signal, and a data line through which data is transmitted is designated by the same reference numeral as the name of the data.

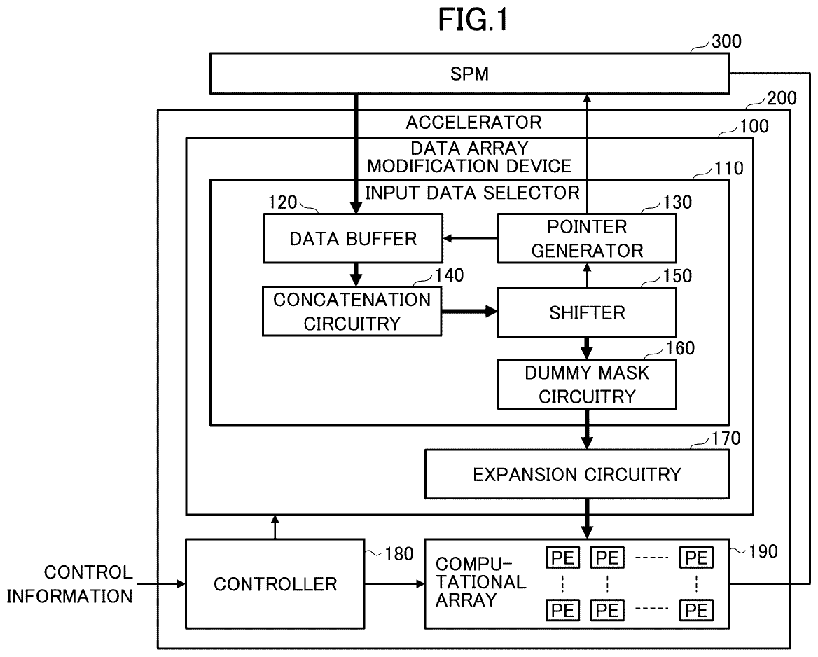

FIG. 1 illustrates an example of a data array modification device according to an embodiment. For example, a data array modification device 100 illustrated in FIG. 1 is provided in an accelerator 200, together with a controller 180 and a computational array 190 that includes plurality of processing elements (PEs). The data array modification device 100 and the computational array 190 are connected to a scratchpad memory (SPM) 300. The PE is an example of a computational element.

The data array modification device 100 includes an input data selector 110 and expansion circuitry 170. The input data selector 110 includes a data buffer 120, a pointer generator 130, concatenation circuitry 140, a shifter 150, and dummy mask circuitry 160. The expansion circuitry 170 is an example of an array generator.

For example, the accelerator 200 repeats an operation of executing a matrix computation or the like of data read from the SPM 300 via the data array modification device 100 by the computational array 190 and an operation of storing an execution result in the SPM 300, performing executing machine learning, such as deep learning or the like, or scientific and technical computation. The controller 180 interprets control information received from an external controller, such as a central processing unit (CPU) or the like, controls an inside of the computational array 190, and controls the data array modification device 100. Examples of the control information with respect to the computational array 190 include a load instruction, a store instruction, and an instruction to perform a matrix multiplication or the like in the computational array 190, for example.

The data array modification device 100 modifies an array of data read from the SPM 300 into an array of data on which a computation can be executed by the computational array 190. In FIG. 1, the data array modification device 100 is disposed inside the accelerator 200, but the data array modification device 100 may be disposed outside the accelerator 200.

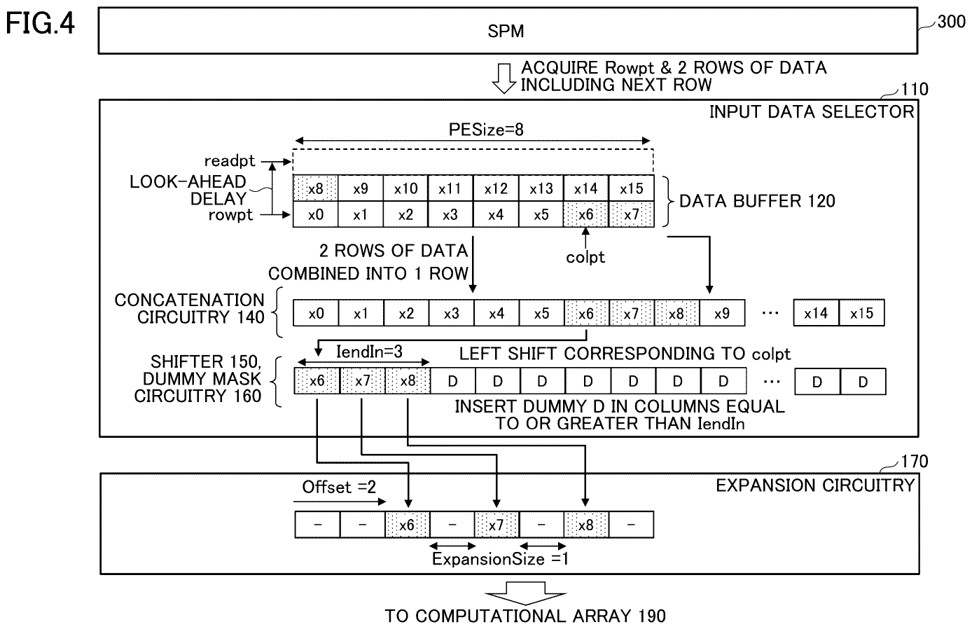

In the input data selector 110, the data buffer 120 holds data of a predetermined size of read from the SPM 300. The pointer generator 130 generates a pointer indicating an area of the SPM 300 from which the data is to be read, and generates a pointer indicating a position in the buffer 120 from which the data is to be read. The input data selector 110 selects a data group including a number of data to be input to the computational array 190 in a single input from among a plurality of data read from an area having consecutive addresses in the SPM 300, and outputs the selected group of data to the expansion circuitry 170. Functions of the concatenation circuitry 140, the shifter 150, and the dummy mask circuitry 160 will be described with reference to FIG. 4.

The expansion circuitry 170 inserts an interval indicated by an inter-data distance (or a data distance) ExpansionSize between the data included in the data group selected by the input data selector 110. In addition, the expansion circuitry 170 shifts the data group by an offset Offset to generate data to be output to the computational array 190, and inputs the generated data to the computational array 190. The inter-data distance ExpansionSize is an example of expansion information, and the offset Offset is an example of offset information.

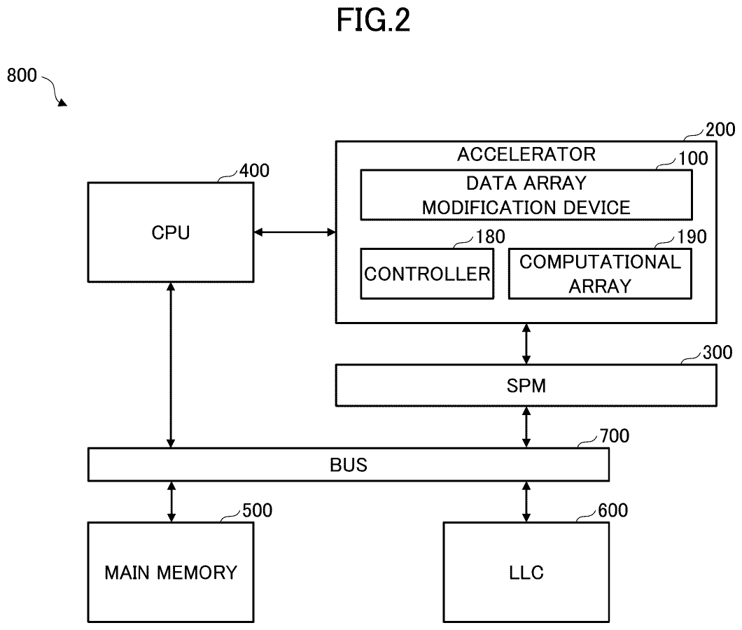

FIG. 2 illustrates an example of an information processing apparatus equipped with the data array modification device 100 of FIG. 1. An information processing apparatus 800 illustrated in FIG. 2 includes the accelerator 200, the SPM 300, a CPU 400, a main memory 500, such as a high bandwidth memory (HBM) or the like, and a last level cache (LLC) 600. The information processing apparatus 800 also includes a bus 700 that connects the SPM 300, the CPU 400, the main memory 500, and the LLC 600 to one another. A configuration of the information processing apparatus 800 equipped with the data array modification device 100 is not limited to the example illustrated in FIG. 2. The CPU 400 controls an operation of the computational array 190. Further, the CPU 400 transfers parameters used for an operation of the data array modification device 100, such as the inter-data distance ExpansionSize, the offset Offset, or the like to the data array modification device 100.

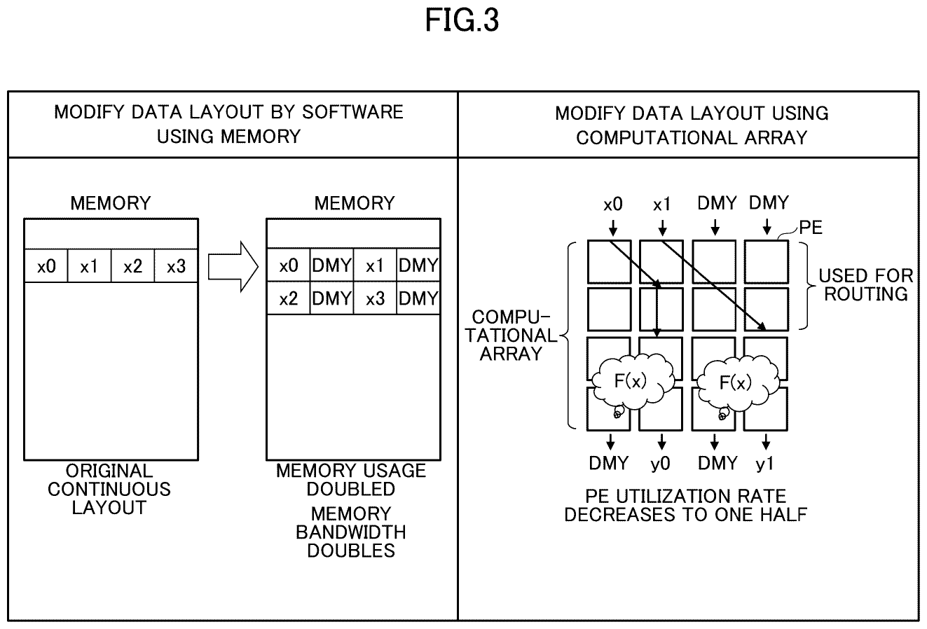

FIG. 3 illustrates a problem in a case where the data array modification device 100 of FIG. 1 is not used. In a case where software is used to provide intervals in data x0 through x3 which are consecutively stored in a certain area of the memory, for example, dummy data DMY is inserted between the consecutive data while transferring the data x0 through x3 to another memory area. In this case, an amount of memory used is doubled, and a memory bandwidth is also doubled.

In a case where the computational array is used to provide an interval between the data x0 and x1, for example, some PEs of the computational array are used for routing. Further, a computation (or an arithmetic operation) F(x) is executed by supplying the data x0 and data x1, inserted with the interval by the routing of the PEs, to the subsequent PEs, and data y0 and y1 are output from the computational array together with the dummy data DMY. In the example using the computational array illustrated in FIG. 3, a utilization rate of the PE that executes the computation F(x), that is, a PE utilization rate, is halved, and a computational efficiency (or a processing efficiency) decreases.

FIG. 4 illustrates an outline of operations of the input data selector 110 and the expansion circuitry 170 illustrated in FIG. 1. In FIG. 4, a code readpt is a read pointer indicating a storage source of a plurality of data to be read next from the SPM 300. A code rowpt is a row pointer indicating a row from which reading of a data group to be input to the computational array 190 is to start. A look-ahead delay indicates a difference between the row pointer rowpt and the read pointer readpt, and indicates a distance to the row of the read pointer readpt that is to acquire the data next. In the example illustrated in FIG. 4, the look-ahead delay is “2”.

A code colpt is a column pointer indicating a column from which reading of the data group to be input to the computational array 190 is to start. A code PESize indicates a number of data input ports (that is, the number of columns) of the computational array 190, and is “8” in the example illustrated in FIG. 4. In the following, PESize is also referred to as a column size.

A code IendIn indicates a number of data (hereinafter also referred to as “data number”) included in the data group to be input to the computational array 190, and is “3” in the example illustrated in FIG. 4. A code Offset indicates a column number (the left end is 0) of the computational array 190 to which head data (x6 in FIG. 4) is input among the data group to be input to the computational array 190 in a single input. The inter-data distance ExpansionSize indicates the interval of the data included in the data group to be input to the computational array 190 in a single input. The column size PESize and the data number IendIn are not limited to the values illustrated in FIG. 4. The offset Offset and the inter-data distance ExpansionSize may be varied according to the size of the computational array 190 and data computation specifications of the computational array 190.

In the example illustrated in FIG. 4, the input data selector 110 acquires two rows of data (16 data of 2 rows×8 columns) having a top row indicated by the row pointer rowpt from among the data held in the SPM 300, and stores the acquired data in the data buffer 120. The input data selector 110 performs an array modification process in units of data x0 through x15 amounting to two rows stored in the data buffer 120. In FIG. 4, a data group x0-x2 of the data x0 through x2 and a data group x3-x5 of data x3 through x5 are already input to the computational array 190 with the interval and the offset inserted by the input data selector 110 and the expansion circuitry 170, respectively, and a data group x6-x8 of the data x6 through x8 indicated by a dot-pattern is a current array to be subjected to the modification (that is, a modification target).

The pointer generator 130 illustrated in FIG. 1 updates the column pointer colpt by “+1” every time each data of the data group to be input to the computational array 190 is retrieved from the data buffer 120. In a case where the column pointer colpt reaches an end of the row, the pointer generator 130 returns the column pointer colpt to the head of the row and updates the row pointer rowpt by “+1”. In a case where new data from the SPM 300 amounting to one row is held in the data buffer 120, the pointer generator 130 updates the read pointer readpt by “+1”.

When the array modification process on the data progresses and the modification target becomes the second row (the upper row) in the data buffer 120, the input data selector 110 acquires the data from the next row in the SPM 300 indicated by the read pointer readpt. The input data selector 110 stores the acquired data in the data buffer 120 to update the data buffer 120.

The concatenation circuitry 140 concatenates 16 data amounting to two rows held in the data buffer 120 and rearranges the concatenated data into one row, thereby facilitating shifting of the data by the shifter 150. In a case where the shifter 150 can directly perform the shift process on a plurality of rows of data held in the data buffer 120, the concatenation circuitry 140 may not be omitted.

The shifter 150 performs a shift process of left-aligning three data to be input to the computational array 190 in a single input among the 16 data of one row concatenated by the concatenation circuitry 140. The dummy mask circuitry 160 performs a masking by arranging the dummy data DMY in a data area that becomes vacant on the right side by the left-aligning of the three data.

The expansion circuitry 170 modifies an array of the three data left-aligned by the shifter 150 according to a position of a supply destination column of the computational array 190, and inputs the data having the modified array to the computational array 190. The computational array 190 executes a computation on the three data having the array modified by the data array modification device 100.

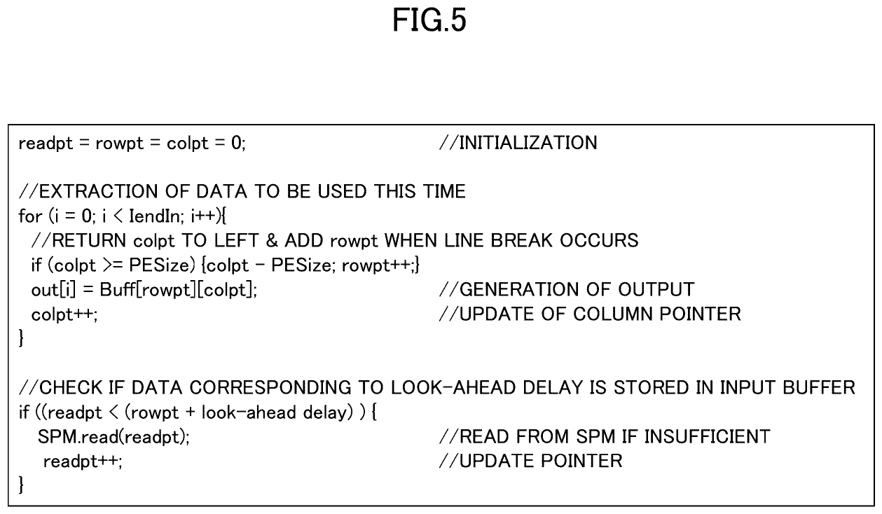

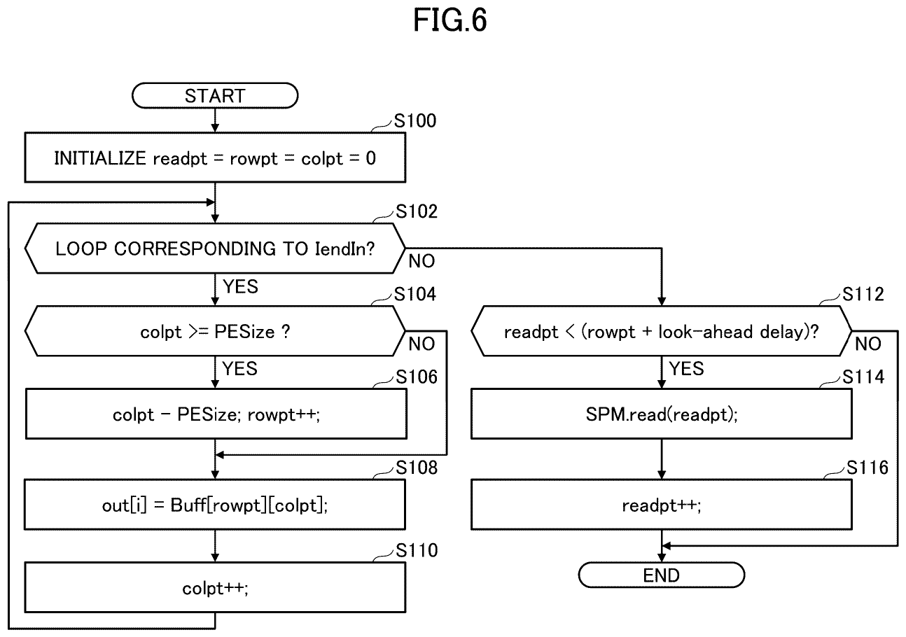

FIG. 5 illustrates an example of an algorithm of an operation in which the input data selector 110 of FIG. 4 acquires data to be processed from the data buffer 120. An example of the process according to the algorithm of FIG. 5 is illustrated by a flow chart of FIG. 6. FIG. 5 illustrates an example of a data array modification program.

FIG. 6 illustrates an example of the flow chart of the operation of the input data selector 110 illustrated in the algorithm of FIG. 5. FIG. 6 illustrates an example of a data array modification method. The algorithm illustrated in FIG. 5 or the flow chart illustrated in FIG. 6 may be implemented by hardware installed in the data array modification device 100, or may be implemented by the data array modification program executed by a computer, such as a CPU or the like, installed in the data array modification device 100. In a case where the operation illustrated in FIG. 6 is performed by executing the data array modification program, the input data selector 110 illustrated in FIG. 4 is implemented by the data array modification program. The data array modification program may be stored in any suitable non-transitory computer-readable storage medium, such as a semiconductor memory device, a magnetic recording medium, a magneto-optical recording medium, an optical recording medium, or the like, for example.

First, in step S100, the input data selector 110 initializes the read pointer readpt, the row pointer rowpt, and the column pointer colpt to “0”. Next, each data of the data group to be input to the computational array 190 in a single input is retrieved by steps S102 through S110. For example, by repeating steps S102 through S110 three times, the data group x0-x2 of the data x0 through x2, the data group x3-x5 of the data x3 through x5, and the data group x6-x8 of the data x6 through x8 illustrated in FIG. 4 are sequentially retrieved.

In step S102, the input data selector 110 determines whether or not to continue a loop process corresponding to the data number IendIn to be input to the computational array 190 in a single input. The data number IendIn indicates the number of data included in the data group. The input data selector 110 performs the process of step S104 in a case where the data to be processed remains and the loop process is to be continued, and performs the process of step S112 in a case where the loop process corresponding to the data number IendIn ends.

In step S104, the input data selector 110 determines whether or not the column pointer colpt is greater than or equal to the column size PESize. In a case where the column pointer colpt is greater than or equal to the column size PESize, the input data selector 110 performs the process of step S106 to process the data of the next row because the processing of one row of the data buffer 120 ended and a line break occurred. On the other hand, in a case where the column pointer colpt is smaller than the column size PESize, the input data selector 110 performs the process of step S108 because unprocessed data is present in the row that is being processed.

In step S106, the input data selector 110 subtracts the row size PESize from the column pointer colpt to return the column pointer colpt to “0”, and increments the row pointer rowpt by “+1” to set the row pointer rowpt to the next row. The input data selector 110 performs the process of step S106 after the process of step S108.

In step S108, the input data selector 110 retrieves the data indicated by the row pointer rowpt and the column pointer colpt in the data buffer 120 as out [i]. Next, in step S110, the input data selector 110 increments the column pointer colpt by “+1” and returns to the operation to the process of step S102.

In step S112, the input data selector 110 determines whether or not the read pointer readpt is smaller than a sum of the row pointer rowpt and the look-ahead delay. In a case where (readpt)<{(rowpt)+(look-ahead delay)} stands, the input data selector 110 performs the process of step S114 to acquire the data of the next row from the SPM 300. In a case where the relationship (readpt)<{(rowpt)+(look-ahead delay)} does not stand, the input data selector 110 ends the operation illustrated in FIG. 6 without acquiring the data from the SPM 300, because data of the next data group not yet retrieved to the row that is being processed remains in the data buffer 120.

In step S114, the input data selector 110 updates the data buffer 120 by reading one row of data from the SPM 300 indicated by the read pointer readpt and storing the read data in the data buffer 120. Next, in step S116, the input data selector 110 sets the read pointer readpt to {(rowpt(+(look-ahead delay)} by adding “+1” to the read pointer readpt, and ends the operation illustrated in FIG. 6.

As described above, the input data selector 110 can autonomously read the data from the SPM 300 and retrieve, from the read data, the data group to be input to the computational array 190 in a single input without being controlled by an external controller or the like. After performing the operation illustrated in FIG. 6, the input data selector 110 autonomously performs the concatenation of the data by the concatenation circuitry 140, the left shift of the data amounting to the data number IendIn by the shifter 150, and the insertion of the dummy data DMY by the dummy mask circuitry 160, which are described above with reference to FIG. 4.

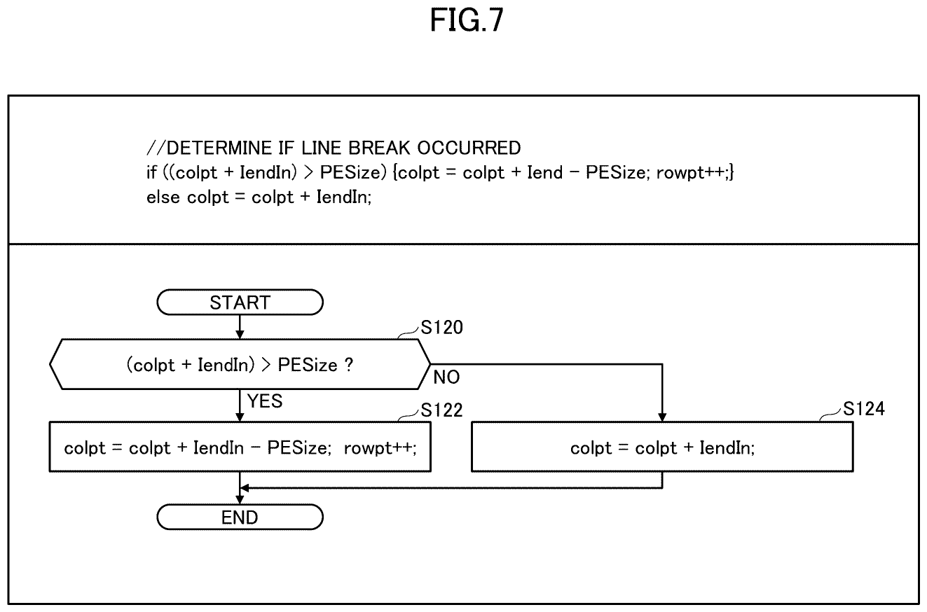

FIG. 7 illustrates an example of an operation of updating a pointer. An upper part of FIG. 7 illustrates an algorithm for updating the pointer, and a lower part of FIG. 7 illustrates an operation of the input data selector indicated by the algorithm. The upper part of FIG. 7 illustrates an example of the data array modification program, and the lower part of FIG. 7 illustrates an example of the data array modification method. A flow chart illustrated in the lower part of FIG. 7 may be implemented by hardware installed in the data array modification device 100, or may be implemented by the data array modification program executed by a computer, such as a CPU or the like, installed in the data array modification device 100. The data array modification program may be stored in any suitable non-transitory computer-readable storage medium, such as a semiconductor memory device, a magnetic recording medium, a magneto-optical recording medium, an optical recording medium, or the like.

First, in step S120, the input data selector 110 determines whether or not a sum of the column pointer colpt and the data number IendIn is greater than the column size PESize. In a case where a relationship {(colpt)+(IendIn)}>(PESize) stands, the row from which the data is to be retrieved is updated, and thus, the process of step S122 is performed. In a case where the relationship {(colpt)+(IendIn)}>(PESize) does not stand, the row from which the data is to be retrieved is not updated, and thus, the process of step S124 is performed.

In step S122, the input data selector 110 sets a value that is obtained by subtracting the column size PESize from a value obtained by adding the data number IendIn to the column pointer colpt as a new column pointer colpt, and sets the row pointer rowpt to the next row by adding “+1” to the row pointer rowpt. In step S124, the input data selector 110 sets a value that is obtained by adding the data number IendIn to the column pointer colpt as the new column pointer colpt. After performing the process of step S122 or S124, the input data selector 110 ends the operation illustrated in FIG. 7.

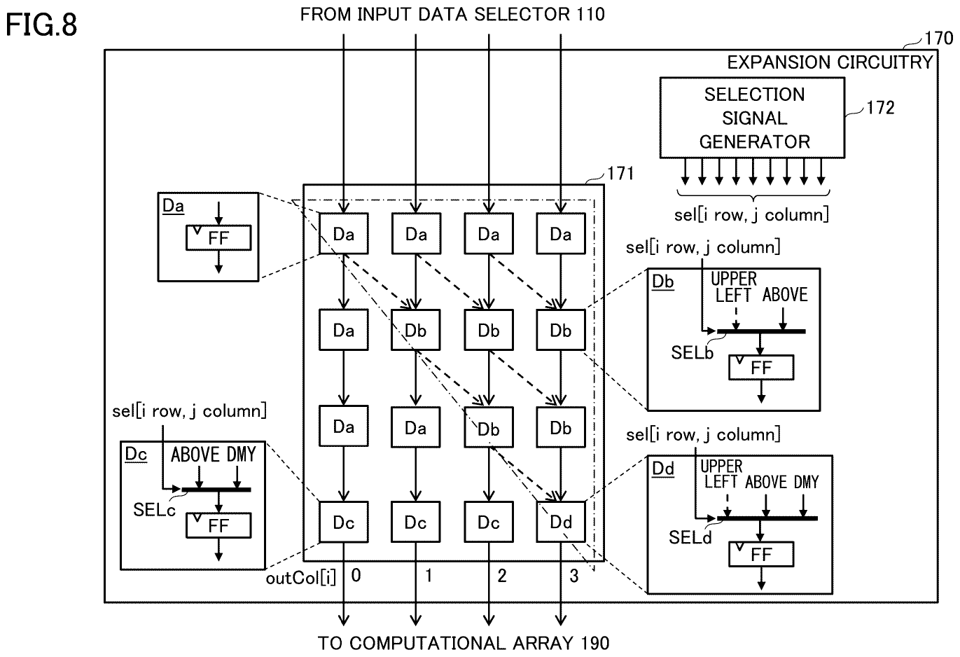

FIG. 8 illustrates an example of a configuration of the expansion circuitry 170 illustrated in FIG. 4. The expansion circuitry 170 includes a data holding array 171 and a selection signal generator 172. The data holding array 171 includes a plurality of data holding elements D (Da, Db, Dc, and Dd) arranged in a matrix of m rows and m columns, where m is an integer greater than or equal to 2. In the example illustrated in FIG. 8, the data holding array 171 includes four rows by four columns of data holding elements D according to columns outCol[0] through outCol[3] to be input to the computational array 190. The computational array 190 having four rows by four columns of PEs is connected to an output of the data holding array 171 illustrated in FIG. 8. A size of the data holding array 171 may be two rows by two columns or greater, and the row size and the column size of the data holding array 171 may be the same according to the size of the computational array 190.

A dashed arrow inside the data holding array 171 indicates a path of the data received from the data holding element D diagonally up to the left. As illustrated in FIG. 8, the data transfer from the data holding element D diagonally up to the left is performed by the data holding elements D included in a triangular region indicated by a one-dot chain line with an upper side as a base of the triangular region and a lower right as a vertex of the triangular region. In a case where the computational array 190 has 8 rows by 8 columns of PEs, the expansion circuitry 170 includes 8 rows by 8 columns of data holding elements D. In a case where the computational array 190 has 16 rows by 16 columns of PEs, the expansion circuitry 170 includes 16 rows by 16 columns of data holding elements D.

The data holding element Da includes a flip-flop circuit FF that holds and outputs data input from above. The data holding element Db has functions of selecting data input from the upper data holding element D or the upper left data holding element D by a selector SELb according to a selection signal sel, holding the selected data in the flip-flop circuit FF, and outputting the held data.

The data holding element Dc has functions of selecting data input from the upper data holding element D or dummy data DMY supplied from a dummy data line by a selector SELc according to the selection signal sel, holding the selected data in the flip-flop circuit FF, and outputting the held data. The data holding element Dd has functions of selecting one of the data input from the upper data holding element D, the data input from the upper left data holding element D, or the dummy data DMY by a selector SELd according to the selection signal sel, holding the selected data in the flip-flop circuit FF, and outputting the held data.

The selection signal generator 172 has a function of generating a selection signal sel[i rows, i columns] for every holding element D according to the inter-data distance ExpansionSize and the offset Offset. A logical value of the selection signal sel[i row, i column] generated by the selection signal generator 172 is set when the inter-data distance ExpansionSize and the offset Offset are determined, and is maintained until the inter-data distance ExpansionSize and the offset Offset are varied.

Accordingly, the expansion circuitry 170 can autonomously modify the column to which each data of the data group is to be output according to the offset Offset and the inter-data distance ExpansionSize, without being controlled by an external controller or the like. Further, the expansion circuitry 170 can output each data of the data group from one of output terminals outCol[0] through outCol[3].

In addition, a path for receiving data from the upper left data holding element D is connected only to the data holding elements D in the second and subsequent rows included in the triangular region indicated by the one-dot chain line. The data holding elements D in the second and subsequent columns not included in the triangular region are not connected to the path for receiving the data from the upper left data holding element D. Hence, it possible to reduce the circuit scale of the selector SEL, and to reduce the circuit scale of the expansion circuitry 170.

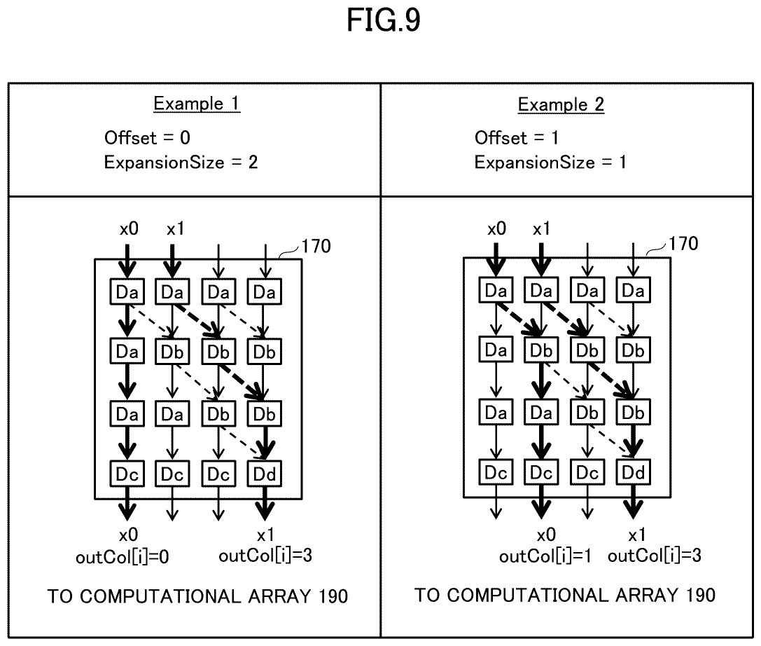

FIG. 9 illustrates an outline of an operation of the expansion circuitry 170 of FIG. 8. In FIG. 9, the data number IendIn of the data group to be input to the computational array 190 in a single input is “2”. In an example 1, the array of the data x0 and x1 input from the upper left of the expansion circuitry 170 is modified using Offset=0 and ExpansionSize=2 and supplied to the computational array 190. In the example 1, the data x0 is sequentially transferred to the data holding element immediately below. Further, the data x1 is transferred twice to a data transfer element diagonally down to the right, sequentially transferred to the data holding element D immediately below after reaching the column to which the data x1 is to be output, and output to the column outCol[i]=0, 3.

In an example 2 illustrated in FIG. 9, the array of the data x0 and x1 input from the upper left of the expansion circuitry 170 are modified using Offset=1 and ExpansionSize=1 and supplied to the computational array 190. In the example 2, the data x0 is transferred once to a data transfer element diagonally down to the right, and is sequentially transferred to the data holding element D directly below after reaching the column to output the data x0. The data x1 is transferred twice to a data transfer element diagonally down to the right, sequentially transferred to the data holding element D immediately below after reaching the column to which the data x1 is to be output, and output to the column outCol[i]=1, 3.

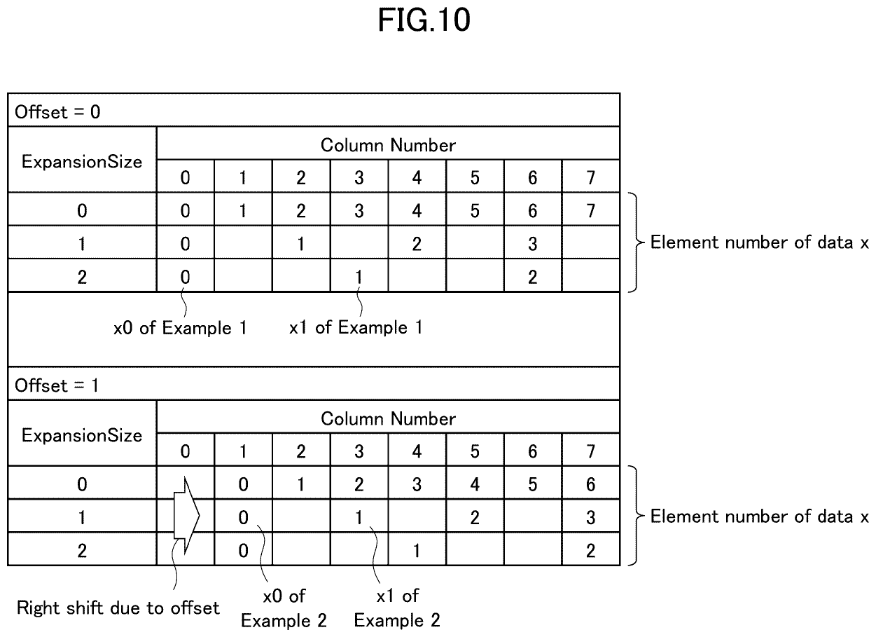

FIG. 10 illustrates features in a case where a data array in a column direction is modified by the expansion circuitry 170 of FIG. 8. In a case where the offset Offset is “0”, each data is output only from a column including a divisor, using the divisor obtained by dividing the column number by the inter-data distance ExpansionSize as an element number. In other words, the data input to the expansion circuitry 170 is output from a column having a column number greater than or equal to the element number of the data, and is not output from a column having a column number smaller than the element number of the data. In the example 1 (Offset=0, ExpansionSize=2) of FIG. 9, the data x0 (element number=0) is output from a column 0 including a divisor=0, and the data x1 (element number=1) is output from a column 3 including a divisor=1.

In a case where the offset Offset is greater than or equal to “1”, the column to which the data is to be output can be obtained by shifting the column to which the data is output when the offset Offset is “0” to the right by the offset Offset. For example, in the example 2 (Offset=1, ExpansionSize=1) of FIG. 9, the data x0 (element number=0) is output from a column 1 including the divisor=0, and the data x1 (element number=1) is output from the column 3 including the divisor=1. The larger the element number is, the larger the column number of the column from which the data is output becomes, and the data is not output from a column having a smaller column number. Hence, there is a restriction on the data array after the expansion performed by the expansion circuitry 170.

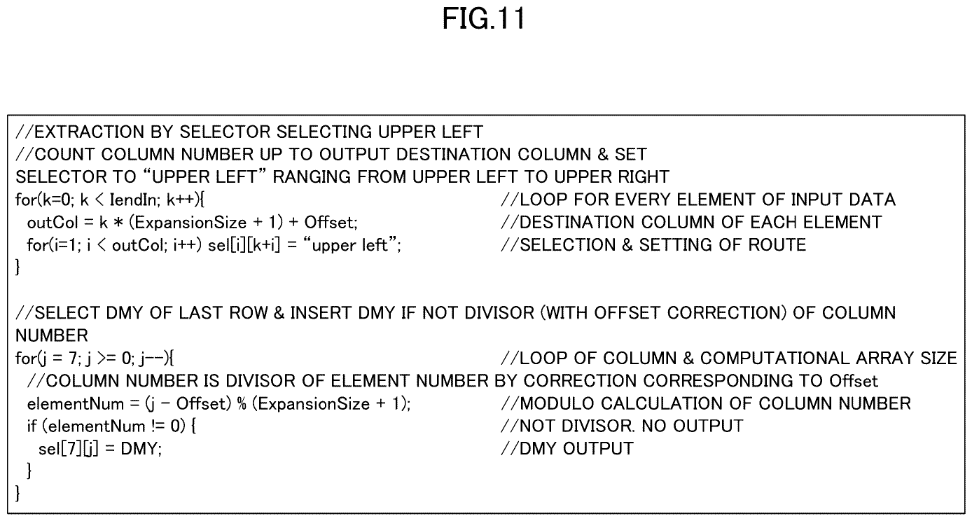

FIG. 11 illustrates an example of an algorithm for generating the selection signal sel in the expansion circuitry 170 illustrated in FIG. 8. In the algorithm illustrated in FIG. 11, the logic of the selection signal sel supplied to the selector SEL of each data holding element D of the expansion circuitry 170 is determined using parameters such as the offset Offset and the inter-data distance ExpansionSize. FIG. 11 illustrates an example of the data array modification program.

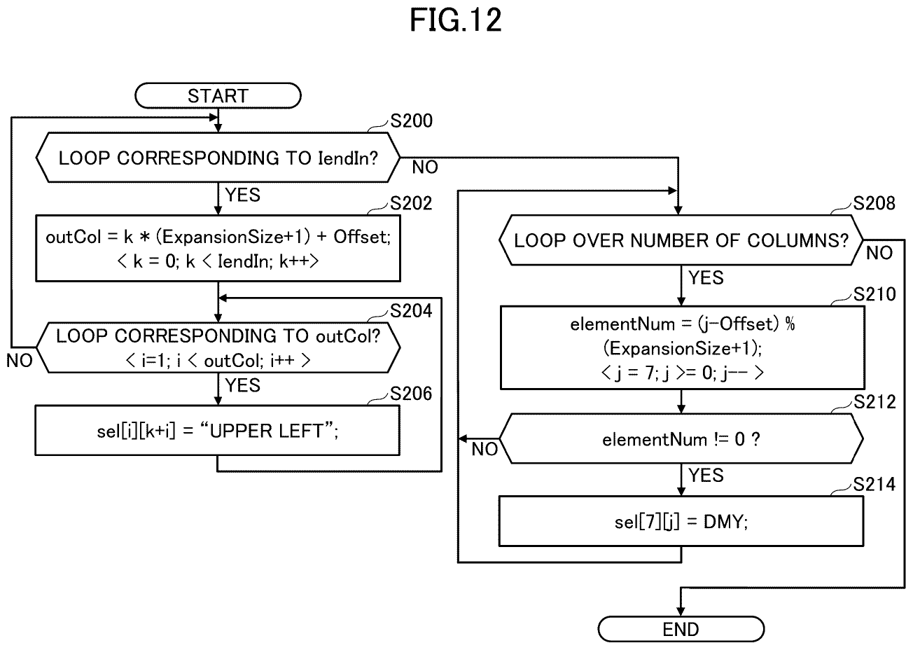

The algorithm illustrated in FIG. 11 may be executed at a frequency similar to a mapping modification frequency of the PEs included in the computational array 190, or may be executed by software in advance before the computation is performed by the computational array 190. After the logic of the selection signal sel is set, the expansion circuitry 170 switches the selector SEL according to the logic of the selection signal sel, and expands the data received from the input data selector 110 according to the setting. FIG. 11 illustrates the algorithm for generating the selection signal sel in a case where the computational array 190 has 8 rows by 8 columns of PEs. In addition, the process according to the algorithm of FIG. 11 is illustrated by a flow chart of FIG. 12.

FIG. 12 is a flow chart illustrating an example of a procedure for generating the selection signal sel illustrated by an algorithm of the expansion circuitry 170 of FIG. 11. FIG. 12 illustrates an example of the data array modification method. The flow chart illustrated in FIG. 12 may be implemented by hardware installed in the data array modification device 100, or may be implemented by the data array modification program executed by a computer, such as a CPU or the like, installed in the data array modification device 100. In the examples illustrated in FIG. 11 and FIG. 12, the computational array 190 includes 8 rows by and 8 columns of PEs, and the number of data inputs is 8 (that is, 8 columns).

First, in step S200, the expansion circuitry 170 determines whether or not to continue the loop process corresponding to the data number IendIn. The expansion circuitry 170 performs the process of step S202 to continue the loop process in a case where the loop process corresponding to the data number IendIn does not end, and performs the process of step S208 in a case where the loop process corresponding to the data number IendIn ends. In step S202, the expansion circuitry 170 computes the column outCol to which the data is to be output for every data corresponding to the data number IendIn.

In the example 1 (offset=1, ExpansionSize=2) in FIG. 9, an output destination of the data x0 (k=0) is computed as the column outCol[0], and an output destination of the data x1 (k=1) is computed as the column outCol[3]. In the example 2 (Offset=1, ExpansionSize=1) in FIG. 9, the output destination of the data x0 (k=0) is computed as the column outCol[1], and the output destination of the data x1 (k=1) is computed as the column outCol[3].

Next, in step S204, the expansion circuitry 170 determines whether or not to continue the loop process corresponding to outCol for every outCol computed in step S202. The expansion circuitry 170 performs the process of step S206 in a case where the loop process for every outCol remains and the loop process is to be continued, and returns to the process of step S200 in a case where the loop process for every outCol ends.

Next, in step S206, the expansion circuitry 170 sets the selection signal sel[i][k+1] so as to select the data from the upper left data holding element D. In a case where the loop process for every outCol ends, the expansion circuitry 170 sets the selection signal sel[i][j] so as to select the data from the data holding element D immediately above until the data holding element D in the last row.

Accordingly, in the path of the data x0 in the example 1 in FIG. 9, the selection signal sel[i][j] can be autonomously set so that the data holding elements D in the second, third, and fourth rows from the top select the data holding elements D immediately above. In the path of data x1 in the example 1 in FIG. 9, the selection signal sel[i][j] can be autonomously set so that the data holding elements D in the second and third rows from the top select the data holding elements D in the upper left, and the data holding element D in the fourth row selects the data holding element D immediately above.

In the path of the data x0 in the example 2 in FIG. 9, the selection signal sel[i][j] can be autonomously set so that the data holding element D in the second row from the top selects the data holding element D in the upper left, and the data holding elements D in the third and fourth rows from the top select the data holding elements D immediately above. Similar to the example 1, in the path of the data x1 in the example 2 in FIG. 9, the selection signal sel[i][j] can be autonomously set so that the data holding elements D in the second and third rows from the top select the upper left data holding elements D and the data holding element D in the fourth row selects the data holding element D immediately above.

In step S208, the expansion circuitry 170 determines whether or not to continue the loop process corresponding to loops of the number columns. The expansion circuitry 170 performs the process of step S210 in a case where the loop process corresponding to loops of the number of columns remains and the loop process is to be continued, and ends the operation illustrated in FIG. 12 in a case where the loop process corresponding to loops of the number of columns ends.

In step S210, the expansion circuitry 170 computes a remainder elementNum by dividing a value corrected by subtracting the offset Offset from a parameter j by (ExpansionSize+1). That is, the expansion circuitry 170 computes whether or not there is a divisor (that is, whether or not the corrected value is divisible) based on the offset Offset and the inter-data distance ExpansionSize, for every column to be output to the computational array 190.

Next, in step S212, the expansion circuitry 170 performs the process of step S214 in a case where the remainder elementNum is not 0, and returns to the process of step S208 in a case where the remainder elementNum is 0 (that is, in a case where the remainder elementNum is a divisor). Next, in step S214, the expansion circuitry 170 causes the data holding element D selected in step S210 to select the dummy data DMY, and returns to the process of step S208. In this manner, the expansion circuitry 170 can determine whether or not to insert the dummy data DMY according to whether the remainder element Num is a divisor.

As described above, in the embodiment illustrated in FIG. 1 through FIG. 12, the input data selector 110 can autonomously read the data from the SPM 300 and retrieve, from the read data, the data group to be input to the computational array 190 in a single input, without being controlled by an external controller or the like.

For example, the input data selector 110 may use the row pointer rowpt, the column pointer colpt, and the read pointer readpt to transfer the data from the SPM 300 to the buffer 120. In addition, the input data selector 110 can retrieve the data group to be input to the computational array 190 in a single input from the data buffer 120 using the row pointer rowpt, the column pointer colpt, the column size PESize, and the data number IendInt.

The expansion circuitry 170 can autonomously modify the column to which each data of the data group is to be output according to the offset Offset and the inter-data distance ExpansionSize, without being controlled by an external controller or the like. Further, the expansion circuitry 170 can output each data of the data group from one of the output terminals outCol[0] through outCol[3]. Because circuit elements of the data array modification device 100 are not included in the computational array 190, it is possible to reduce the load on the controller that controls the computational array 190, while suppressing deterioration in the performance of the computational array 190.

A plurality of data holding elements D arranged in a matrix are provided in the expansion circuitry 170, and a path for receiving data from the upper left data holding element D is connected only to the data holding elements D in the second and subsequent rows included in a triangular region indicated by a one-dot chain line in FIG. 8. According to this configuration, it possible to reduce the circuit scale of the selector SEL in the data holding elements D not included in the triangular region, and to reduce the circuit scale of the expansion circuitry 170.

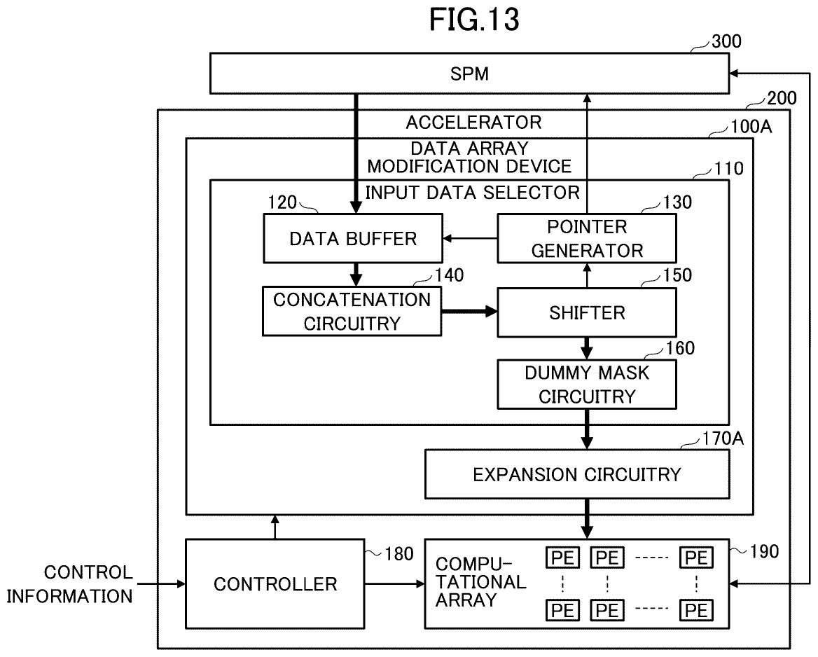

FIG. 13 illustrates an example of the data array modification device according to another embodiment. In FIG. 13, constituent elements that are the same as those illustrated in FIG. 1 are designated by the same reference numerals, and a detailed description thereof will be omitted. A data array modification device 100A illustrated in FIG. 13 has the same configuration as that of the data array modification device 100 illustrated in FIG. 1, except that the data array modification device 100A includes expansion circuitry 170A in place of the expansion circuitry 170 illustrated in FIG. 1. The expansion circuitry 170A has functions of transposition circuitry in addition to the functions of the expansion circuitry 170 illustrated in FIG. 8. The accelerator 200 including the data array modification device 100A and the computational array 190 is connected to the SPM 300.

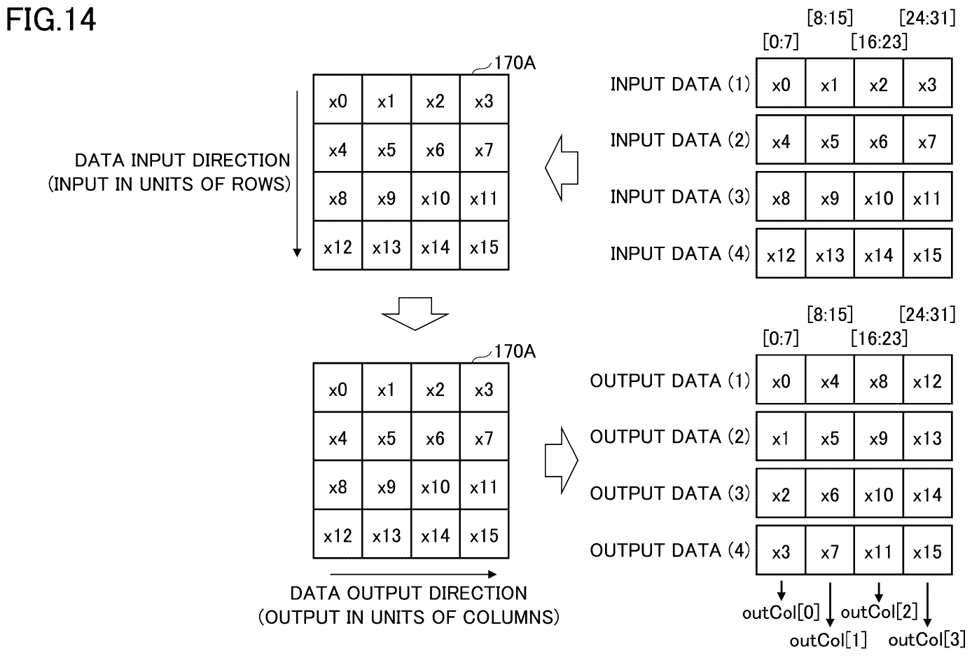

FIG. 14 illustrates an outline of functions of the transposition circuitry included in the expansion circuitry 170A of FIG. 13. Although FIG. 14 illustrates an example in which the expansion circuitry 170A has a size of four rows by four columns, the size of the expansion circuitry 170A may be two rows by two columns or larger, and the row size and the row size may be the same according to the size of the computational array 190. In FIG. 14, the data size is 8 bits, but may be 4 bits, 16 bits, 32 bits, or the like. When functioning as the transposition circuitry, the expansion circuitry 170A inputs the data in units of rows, such as the data group x0-x3, the data group x4-x7, or the like, and outputs the data from the output terminals outCol[0] through outCol[3] in units of columns, such as the data x0, x4, x8, and x12, or the data x1, x5, x9, and x13, or the like.

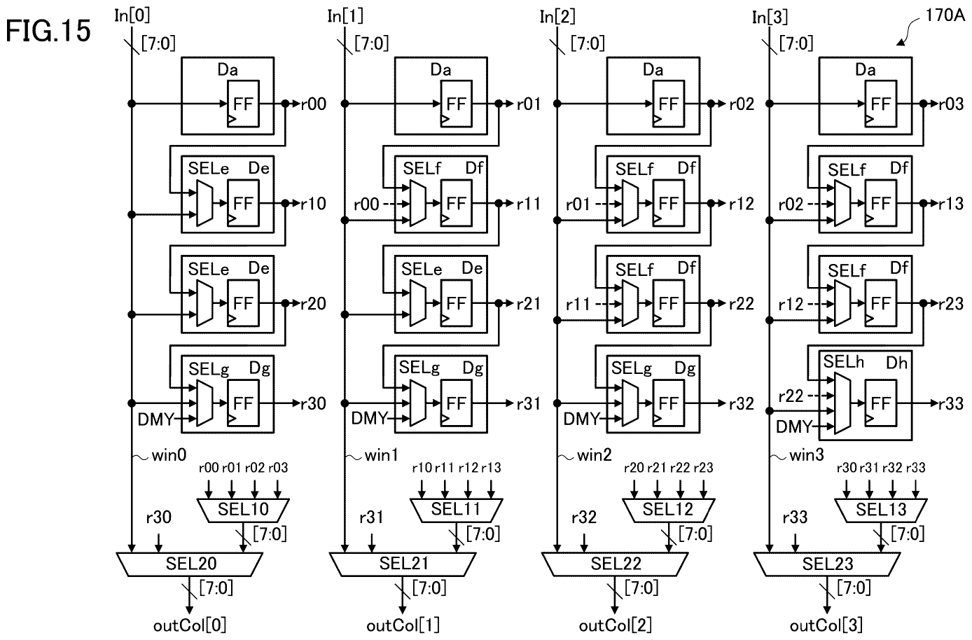

FIG. 15 illustrates an example of the configuration of the expansion circuitry 170A of FIG. 13. In FIG. 15, the data size is 8 bits, as in FIG. 14. The data holding elements D (Da, De, Df, Dg, and Dh) of the expansion circuitry 170A illustrated in FIG. 15 are arranged in four rows by four columns, similar to the expansion circuitry 170 illustrated in FIG. 8. Inputs In[0] through In[3] of the expansion circuitry 170A connected to the data holding elements Da, De, Df, Dg, and Dh are used to input the data to be transposed.

The data holding element Da has the same configuration as the data holding element Da in FIG. 8. The data holding element De has functions of selecting one of the data input from the upper data holding element D or the data input from the input In (one of inthrough in3) by a selector SELe according to a selection signal (not illustrated), holding the selected data in a flip-flop circuit FF, and outputting the held data.

The data holding element Df has functions of selecting one of the data input from the upper data holding element D, the data input from the input In, or the data input from the upper left data holding element D by a selector SELf according to a selection signal (not illustrated), holding the selected data in a flip-flop circuit FF, and outputting the held data. FIG. 15 illustrates the path of the data output from the upper left data holding element D and input to the lower right data holding element D.

The data holding element Dg has functions of selecting one of the data input from the upper data holding element D, the data input from the input In, or the dummy data DMY by a selector SELg according to a selection signal (not illustrated), holding the selected data by a flip-flop circuit FF, and outputting the held data.

The data holding element Dh has a function of selecting one of the data input from the upper data holding element D, the data input from the upper left data holding element D, the data input from the input In, or the dummy data DMY by a selector SELf according to a selection signal (not illustrated). The data holding element Dh has a function of holding the selected data in a flip-flop circuit FF and outputting the held data. Hereinafter, when describing the selectors SELe, SELf, SELg, and SELh without distinction, these selectors are also simply referred to as selectors SEL.

The expansion circuitry 170A includes selectors SEL1 (SEL10 through SEL13) and SEL2 (SEL20 through SEL23). The selectors SEL10 through SEL13 are examples of a first selector, and the selectors SEL20 through SEL23 are examples of a second selector.

The selector SEL10 sequentially selects the data output from the four data holding elements D in the first row (the uppermost row) according to a selection signal (not illustrated), and can sequentially output the data x0 through x3 illustrated in FIG. 14, for example. The selector SEL11 sequentially selects the data output from the four data holding elements D in the second row according to a selection signal (not illustrated), and can sequentially output the data x4 through x7 illustrated in FIG. 14, for example.

The selector SEL12 sequentially selects the data output from the four data holding elements D in the third row according to a selection signal (not illustrated), and can sequentially output the data x8 through x11 illustrated in FIG. 14, for example. The selector SEL13 sequentially selects the data output from the four data holding elements D in the fourth row (the lowermost row) according to a selection signal (not illustrated), and can sequentially output the data x12 through x15 illustrated in FIG. 14, for example.

That is, the selectors SEL10 through SEL13 are used when the data is to be transposed. When transposing the data, the expansion circuitry 170A operates a counter (not illustrated) that counts the number of rows of the data holding elements D, and sequentially operates the selectors SEL of the data holding elements D of the first through fourth rows, thereby storing the data to be transposed in the data holding elements D for every row. In addition, when transposing the data, the expansion circuitry 170A operates a counter (not illustrated) for counting the columns, and causes the selectors SEL10 through SEL13 to sequentially select the data of the first through fourth columns, respectively. The expansion circuitry 170A sequentially outputs the transposed data from the output terminals outCol[0] through outCol[3].

The expansion circuitry 170A includes the selectors SEL of the data holding elements De, Df, Dg, and Dh, and a selection signal generator (not illustrated) that generates the selection signals for controlling switching of the selectors SEL10 through SEL13 and the selectors SEL20 through SEL23, as in FIG. 8. In addition, as in FIG. 8 and FIG. 9, in a case where the expansion circuitry 170A is used to modify the data array in the column direction of the data to be supplied to the computational array 190, the data supplied from the inputs In[0] through In[3] is held only in the data holding elements D in the first row, and is sequentially transferred to the data holding elements D in the second and subsequent rows.

The selector SEL20 selects one of the input In[0], the output of the data holding element Dg in the fourth row connected to the input In[0], or the output of the selector SEL10 according to a selection signal (not illustrated), and outputs the selected output to the output terminal outCol[0]. The selector SEL21 selects the inputs In[1], the outputs of the data holding elements Dg in the fourth row connected to the inputs In[1], or the outputs of the selector SEL11 according to a selection signal (not illustrated), and outputs the selected outputs to the output terminal outCol[1].

The selector SEL22 selects the input In[2], the output of the data holding elements Dg in the fourth row connected to the input In[2], or the output of the selector SEL12 according to a selection signal (not illustrated), and outputs the selected output to the output terminal outCol[2]. The selector SEL23 selects the output of the data holding element Dg in the fourth row connected to the inputs In[3] and In[2], the output of the data holding element Dg in the fourth row connected to the input In[3], or the output of the selector SEL13 according to a selection signal (not illustrated). The selector SEL23 outputs the data to be transferred to the selected path to the output terminal outCol[3].

Data win0 through win3 from the inputs In[0] through In[3] received by the selectors SEL20 through SEL23, respectively, are used when the data is to be output without being transposed. Accordingly, the expansion circuitry 170A can share the function of modifying the data array in the column direction and the function of transposing the data in a single circuit, and it is possible to suppress an increase in the circuit scale when the function of transposing the data is to be added.

As described above, the embodiment illustrated in FIG. 13 through FIG. 15 can also obtain the same effects as those obtainable by the embodiment illustrated in FIG. 1 through FIG. 12. For example, the input data selector 110 can autonomously read the data from the SPM 300 and retrieve, from the read data, the data group to be input to the computational array 190 in a single input, without being controlled by an external controller or the like.

The expansion circuitry 170 can autonomously modify the column to which each data of the data group is to be output according to the offset Offset and the inter-data distance ExpansionSize, without being controlled by an external controller or the like, and can output the data from one of the output terminals outCol[0] through outCol[3]. Because the circuit elements of the data array modification device 100 are not included in the computational array 190, it is possible to reduce the load on the controller that controls the computational array 190 while suppressing deterioration in the performance of the computational array 190.

Further, in the embodiment illustrated in FIG. 13 through FIG. 15, the expansion circuitry 170A can share the function of modifying the data array in the column direction (that is, the data array modification function) and the function of transposing the data (that is, the data transposition function) in a single circuit. As a result, when the data transposition function is added to the expansion circuitry 170 illustrated in FIG. 8, it is possible to suppress an increase in the circuit scale.

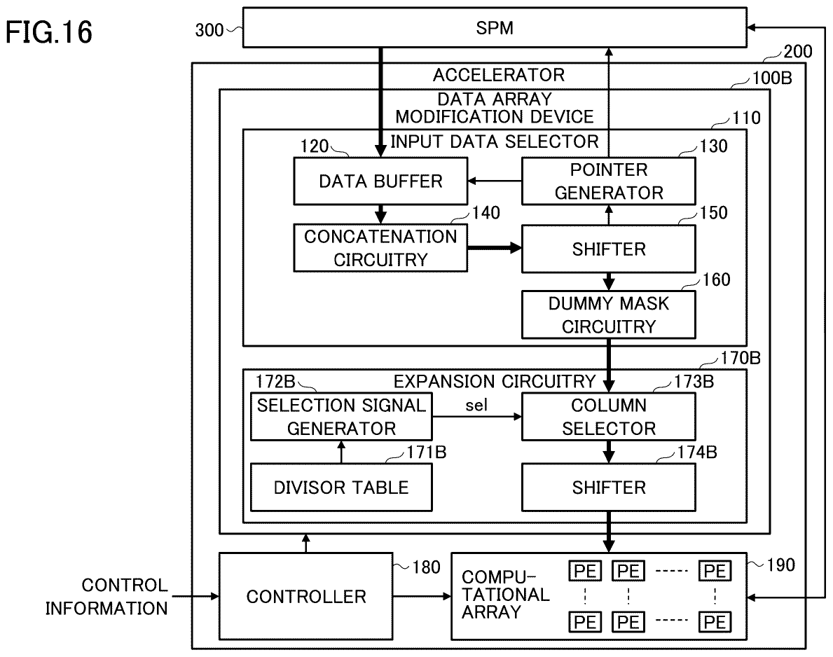

FIG. 16 illustrates an example of the data array modification device according to another embodiment. In FIG. 16, constituent elements that are the same as those illustrated in FIG. 1 are designated by the same reference numerals, and a detailed description thereof will be omitted. A data array modification device 100B illustrated in FIG. 16 has the same configuration as that of the data array modification device 100 illustrated in FIG. 1, except that the data array modification device 100B includes expansion circuitry 170B in place of the expansion circuitry 170 illustrated in FIG. 1. The accelerator 200 including the data array modification device 100B and the computational array 190 is connected to the SPM 300. The expansion circuitry 170B includes a divisor table 171B, a selection signal generator 172B, and a column selector 173B.

The expansion circuitry 170 of the embodiment described above with reference to FIG. 8 uses two rows and two columns of data holding elements D to perform, in parallel, the process of modifying the column to which the data is to be output based on the inter-data distance ExpansionSize and the process of shifting the column to which the data is to be output based on the offset Offset. On the other hand, in the present embodiment, the process of modifying the column to which the data is to be output based on the inter-data distance ExpansionSize is independently performed by the column selector 173B, and the process of shifting the column to which the data is to be output based on the offset Offset is independently performed by the shifter 174B. The shifter 174B can be formed by a simple shift register.

The column selector 173B is an example of a first array generator that generates a first data array by inserting an interval indicated by the inter-data distance ExpansionSize between the data included in the data group selected by the input data selector 110. The shifter 174B is an example of a second array generator that generates a second data array by shifting the first data array by an offset indicated by the offset Offset and inputs the generated second data array to the PEs in the first stage (first row) of the computational array 190.

Some users of the accelerator 200 may request to use only one of the process of modifying the column to which the data is to be output or the process of shifting the column to which the data is to be output. In addition, some users may request to change or extend only the parameters used for the process of modifying the column to which the data is to be output. In the present embodiment, such user's request can be satisfied by modifying the design or the functions of only one of the column selector 173B or the shifter 174B, and improve functional expandability. In addition, it is possible to prevent verification of the design modification or the function modification from becoming complex, and to reduce the man-hours required for the verification tasks, for example.

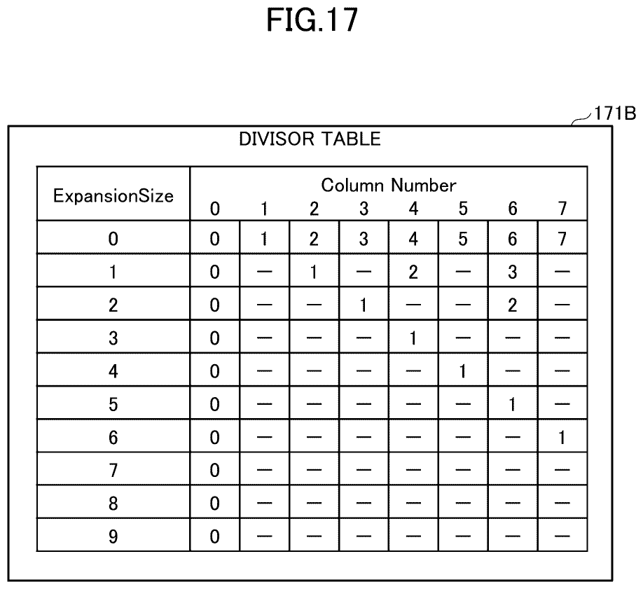

The divisor table 171B includes information indicating the column of the computational array 190 to which the data received from the input data selector 110 is to be supplied for every inter-data distance ExpansionSize. An example of the divisor table 171B is illustrated in FIG. 17.

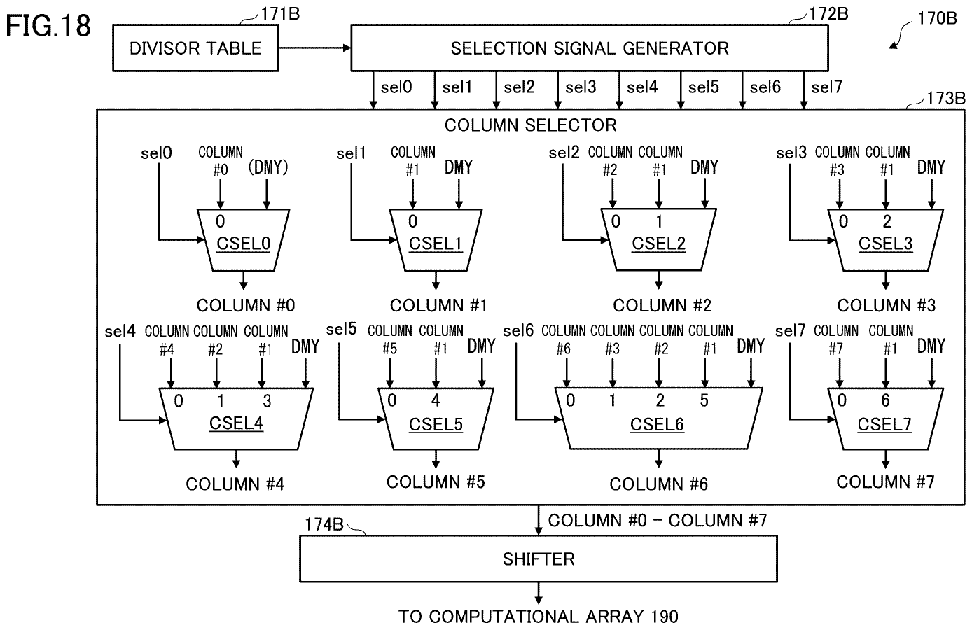

The selection signal generator 172B refers to the divisor table 171B to determine the column of the computational array 190 to which the data received from the input data selector 110 is to be supplied in a case where the offset Offset is “0” for the specified inter-data distance ExpansionSize. The selection signal generator 172B outputs the selection signal sel to the column selector 173B according to the determination result of the selection signal generator 172B. The column selector 173B outputs the data included in the data group received from the input data selector 110 to the shifter 174B at intervals according to the selection signal sel from the selection signal generator 172B. An example of the column selector 173B is illustrated in FIG. 18.

FIG. 17 illustrates an example of the divisor table 171B of FIG. 16. FIG. 17 illustrates the divisor table 171B corresponding to the computational array 190 having 8 rows and 8 columns when the offset Offset is “0”. Because the process of shifting the column to which the data is to be output based on the offset Offset is performed by the shifter 174B, the divisor table 171B can be created without taking the offset Offset into consideration. The numbers in the divisor table 171B indicate divisors for every column number. For example, the divisors of the column number 2 are “2” and “1”, the divisors of the column number 3 are “3” and “1”, and the divisors of the column number 4 are “4”, “2”, and “1”. The symbol “-” indicates that there is no divisor.

The column of the computational array 190 to which the data received from the input data selector 110 is to be supplied in a case where the offset Offset is “0” and the column to which the dummy data DMY is to be supplied can be obtained from the following formula (1).
(column number% (expansionsize+1)==0)?(column number/(expansionsize+1)): DMY---(1)

The formula (1) indicates that the data is supplied to the column having a column number divisible by (ExpansionSize+1), and that the dummy data DMY is supplied to the column having a column number not divisible by (ExpansionSize+1). That is, in a case where the offset Offset is “0”, the number of columns of the computational array 190 to which the data can be supplied is limited to a divisor of the column number. Hence, by creating the divisor table 171B in which the divisor for every column number and the inter-data distance ExpansionSize are associated with each other, and referring to the divisor table 171B for every set inter-data distance ExpansionSize, it is possible to easily obtain the column number of the column to which the data is to be supplied. The data of the column having the column number 0 is always output to the computational array 190, regardless of the inter-data distance ExpansionSize. Further, in the divisor table 171B, the dummy data DMY is supplied to the column having the column number indicated by the symbol “-” indicating that there is no divisor.

FIG. 18 illustrates an example of a configuration of the column selector 173B illustrated in FIG. 16. The column selector 173B includes column selectors CSEL (CSEL0 through CSEL7) for every eight columns of the computational array 190. Each column selector CSEL receives an input from the column (at least one of the columns #0 through #7) indicated by the divisor of the corresponding column number in the divisor table 171B, and an input of the dummy data DMY. In addition, the column selectors CSEL output one of the input data or the dummy data DMY to the shifter 174B, according to the respective selection signals sel (sel0 through sel7) output from the selection signal generator 172B. A numerical value added to the input of each column selector CSEL indicates the inter-data distance ExpansionSize.

For example, the column selector CSEL1 receives the data from the column #1 indicated by a divisor 1 corresponding to the column number 1 in the divisor table 171B, and the dummy data DMY. When the inter-data distance ExpansionSize is “0”, the column selector CSEL1 outputs the input data of the column #1 as the data of the column #1 according to the selection signal sel1. When the inter-data distance ExpansionSize is other than “0”, the column selector CSEL2 outputs the dummy data DMY as the data of the column #1 according to the selection signal sel1.

The column selector CSEL2 receives the data from the columns #2 and #1 indicated by divisors 2 and 1 corresponding to the column number 2 in the divisor table 171B, and the dummy data DMY. When the inter-data distance ExpansionSize is “0”, the column selector CSEL2 outputs the input data of the column #2 as the data of the column #2 according to the selection signal sel2. When the inter-data distance ExpansionSize is “1”, the column selector CSEL2 outputs the input data of the column #1 as the data of the column #2 according to the selection signal sel2. When the inter-data distance ExpansionSize is other than “0” and “1”, the column selector CSEL2 outputs the dummy data DMY as the data of the column #2 according to the selection signal sel2.

The column selector CSEL4 receives the data from the columns #4, #2, and #1 indicated by the divisors 4, 2, and 1 corresponding to the column number 4 in the divisor table 171B, and the dummy data DMY. When the inter-data distance ExpansionSize is “0”, the column selector CSEL4 outputs the input data of the column #4 as the data of the column #4 according to the selection signal sel4. When the inter-data distance ExpansionSize is “1”, the column selector CSEL4 outputs the input data of the column #2 as the data of the column #4 according to the selection signal sel4. When the inter-data distance ExpansionSize is “3”, the column selector CSEL4 outputs the input data of the column #1 as the data of the column #4 according to the selection signal sel4. When the inter-data distance ExpansionSize is other than “0”, “1”, and “3”, the column selector CSEL4 outputs the dummy data DMY as the data of the column #4 according to the selection signal sel4.

The operations of the other column selectors CSEL3, CSEL5, CSEL6, and CSEL7 are the same as the operations of the column selectors CSEL2 and CSEL4. The column selector CSEL0 corresponding to the column number 0 outputs the input data of the column #0 to the shifter 174B as the data of the column #0, regardless of the inter-data distance ExpansionSize. For this reason, the column selector CSEL0 receives, from the selection signal generator 172B, the selection signal sel0 that always selects the input data from the column #0. Accordingly, the column selector CSEL0 does not select the dummy data DMY.

In the present embodiment, as illustrated in FIG. 18, the circuit configurations of the column selector 173B and the shifter 174B can be made simpler than the circuit configuration of the data holding array 171 of the expansion circuitry 170 illustrated in FIG. 8. Hence, it possible to reduce the circuit scale of the expansion circuitry 170B to be smaller than the circuit scale of the expansion circuitry 170 in FIG. 9, and to reduce the circuit scale of the accelerator 200.

As described above, the embodiment illustrated in FIG. 16 through FIG. 18 can also obtain the same effects as those obtainable by the embodiments illustrated in FIG. 1 through FIG. 15. For example, the input data selector 110 can autonomously read the data from the SPM 300 and retrieve, from the read data, the data group to be input to the computational array 190 in a single input, without being controlled by an external controller or the like. Because the circuit elements of the data array modification device 100 are not included in the computational array 190, it is possible to reduce the load on the controller that controls the computational array 190 while suppressing deterioration in the performance of the computational array 190.

Further, in the embodiment illustrated in FIG. 16 through FIG. 18, the design or the functions of only one of the column selector 173B or the shifter 174B can be modified according to a request from the user, for example, and it is possible to improve the functional expandability. In addition, it is possible to prevent the verification of the design modification or the function modification from becoming complex, and to reduce the man-hours required for the verification tasks, for example.

By performing the process according to the inter-data distance ExpansionSize in the column selector 173B and performing the process according to the offset Offset in the shifter 174B, the divisor table 171B can be created without taking the offset Offset into consideration. As a result, the divisor table 171B can be created with ease, and the process of generating the selection signal sel by the selection signal generator 172B can be simplified.

The circuit configurations of the column selector 173B and the shifter 174B can be made simpler than the circuit configuration of the data holding array 171 of the expansion circuitry 170 illustrated in FIG. 8. Accordingly, it is possible to reduce the circuit scale of the expansion circuitry 170B to be smaller than the circuit scale of the expansion circuitry 170 illustrated in FIG. 9, and to reduce the circuit scale of the accelerator 200.

According to the embodiments of the present disclosure, it is possible to reduce a load on a controller that controls a computational array while suppressing deterioration in a performance of the computational array, by disposing a data array modification device that modifies an array of data to be supplied to the computational array outside the computational array and autonomously operating the data array modification device.

Various aspects of the subject-matter described herein may be set out non-exhaustively in the following numbered clauses:
1. A non-transitory computer-readable storage medium having stored therein a data array modification program for modifying an array of data read from a memory to an array executable by a computational array including a plurality of computational elements arranged in a matrix, the data array modification program, when executed by a computer, causing the computer to perform a process comprising:
selecting a data group including a predetermined number of first data to be input to the computational array in a single input, from among a plurality of data read from an area having consecutive addresses in the memory; and
generating data to be output to the computational array by inserting an interval between the predetermined number of first data of the selected data group and shifting the data group from a head position.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data array modification device that modifies an array of data read from a memory to an array executable by a computational array including a plurality of computational elements arranged in a matrix, the data array modification device comprising:
an input data selector configured to select a data group including a predetermined number of first data to be input to the computational array in a single input, from among a plurality of data read from an area having consecutive addresses in the memory; and
an array generator configured to generate data to be output to the computational array by inserting an interval between the predetermined number of first data of the data group selected by the input data selector and shifting the data group from a head position.

2. The data array modification device as claimed in claim 1, wherein the array generator inserts an interval indicated by expansion information included in computation specifications of the computational array between the predetermined number of first data, and shifts the data group from the head position by an offset indicated by offset information included in the computation specifications.

3. The data array modification device as claimed in claim 1, wherein the input data selector includes:
a data buffer including multiple rows and multiple columns configured to hold multiple data read from the memory;
a pointer generator configured to generate a read pointer indicating a read source of new multiple data in the memory, a row pointer indicating a row from which reading of the data group is to start, and a column pointer indicating a column from which reading of the data group is to start; and
a shifter configured to retrieve the data group from a position indicated by the row pointer and the column pointer in the data buffer and shift the retrieved data group to the head position, and to output the shifted data group to the array generator.

4. The data array modification device as claimed in claim 3, wherein the pointer generator is configured to:
update the column pointer every time the first data is retrieved from the data buffer, and
return the column pointer to a beginning of the row in a case where the column pointer reaches an end of the row, and the row pointer is updated, and update the read pointer in a case where the multiple new data from the memory are held in the data buffer.

5. The data array modification device as claimed in claim 1, wherein:
the array generator includes a data holding array including a plurality of data holding elements arranged in m rows and m columns, where m is an integer greater than or equal to 2, and a selection signal generator configured to generate a selection signal,
the data holding elements in a first row have a first input coupled to an output of the input data selector,
the data holding elements in a second and subsequent rows have a second input coupled to an output of the data holding element in a preceding row of the same column,
the data holding element in a column having a column number greater than or equal to a row number, among the data holding elements in the second and subsequent rows, has a third input coupled to an output of the data holding element having a column number smaller by one in a preceding row,
the data holding elements in a last row has a fourth input coupled to a dummy data line that receives dummy data,
outputs of the m data holding elements in the last row are coupled to inputs of the m computational elements in a first row of the computational array, respectively, and
each data holding element of the plurality of data holding elements having a plurality of inputs includes a selector configured to select data received by one input of the plurality of inputs according to the selection signal.

6. The data array modification device as claimed in claim 5, wherein the selection signal generator is configured to:
generate a selection signal for causing the data holding elements in the second and subsequent rows to select the third input until the data received by the data holding elements in the first row reaches a column to which the data is to be output, and generate a selection signal for causing the data holding elements in the second and subsequent rows to select the second input after the data received by the data holding elements in the first row reaches the column to which the data is to be output, and
generate a selection signal for causing a data holding element that does not output data among the data holding elements in the last row to select the fourth input.

7. The data array modification device as claimed in claim 5, wherein the array generator further includes:
a fifth input provided in the data holding elements in the second or subsequent rows and coupled to the first input of the data holding elements in the first row of the same column;
a first selector provided in correspondence with an n-th column, and configured to sequentially select outputs of the m data holding elements in an n-th row, where n is an integer from 1 to m; and
a second selector provided in correspondence with the n-th column, and configured to select one of an output of the data holding element in the m-th row of the n-th column, an output corresponding to the n-th column in the input data selector, or an output of the first selector in the n-th column.

8. The data array modification device as claimed in claim 1, wherein the array generator includes:
a first array generator configured to generate data of a first array by inserting an interval indicated by expansion information between the data included in the data group selected by the input data selector; and
a second array generator configured to generate a second array by shifting the data of the first array by an offset indicated by offset information, and input data of the generated second array to the computational element in a first stage of the computational array.

9. An information processing apparatus comprising:
a memory;
a computational array including a plurality of computational elements arranged in a matrix;
a controller configured to control an operation of the computational array; and
a data array modification device configured to modify an array of data read from the memory to an array executable by the computational array,
wherein the data array modification device includes:
an input data selector configured to select a data group including a predetermined number of first data to be input to the computational array in a single input, from among a plurality of data read from an area having consecutive addresses in the memory; and
an array generator configured to generate data to be output to the computational array by inserting an interval between the predetermined number of first data of the data group selected by the input data selector and shifting the data group from a head position.

10. A data array modification method for modifying an array of data read from a memory to an array executable by a computational array including a plurality of computational elements arranged in a matrix, the data array modification method comprising:
selecting a data group including a predetermined number of first data to be input to the computational array in a single input, from among a plurality of data read from an area having consecutive addresses in the memory; and
generating data to be output to the computational array by inserting an interval between the predetermined number of first data of the selected data group and shifting the data group from a head position.
